(19) United States
(12) Patent Application Publication
(10) Pub. No.: US 2010/0018130 A1
(43) Pub. Date: Jan. 28, 2010

(54) Collapsible Buildings And Building Modules

(76) Inventors: Michael Lopez, Queensland (AU); Hayden Wouters, Queensland (AU)

Correspondence Address: ABELMAN, FRAYNE & SCHWAB, 666 THIRD AVENUE, 10TH FLOOR, NEW YORK, NY, 10017, US

(21) Appl. No.: 11/988,149

(22) PCT Filed: Jun. 27, 2006
(86) PCT No.: PCT/AU2006/000905

§ 371 Date: Nov. 7, 2008

(30) Foreign Application Priority Data
Jun. 29, 2005 (AU) 2005903427

(51) Int. Cl. E04B 1/344; E04B 1/343; E04G 21/00; F16C 11/04; E04B 1/38; E04C 2/26; B21D 47/00

(52) U.S. Cl. 52/71; 52/741.1; 16/221; 16/385; 16/374; 16/365; 52/309.9; 29/897.32

(57) ABSTRACT

A collapsible building module including: a floor panel; a plurality of wall panels, each having an upper end and a lower end and being connected to said floor panel at or adjacent their lower ends for pivoting movement relative to said floor panel about respective pivot axes at or adjacent their lower ends between an erected position in which they stand up from said floor panel and a stowed position in which they rest on said floor panel or on top of one another; a roof panel operatively connected to one of said wall panels at or adjacent its upper end for pivoting movement relative thereto about a pivot axis adjacent said upper end; and securing means for securing selected adjacent panels together in the erected position.

### TECHNICAL FIELD OF THE INVENTION

This invention relates to collapsible buildings and building modules.

The invention has particular application to building modules which are adapted to be transported to remote construction sites or natural disaster sites and erected on site without undesirable delay and with only minimal skill. It will be appreciated that in many circumstances on-site building construction is impractical or perhaps impossible where buildings must be constructed quickly by a small number of persons (often unskilled persons), for example, in response to natural diasters. However, the cost of transportation of building modules which are fabricated off site can be prohibitive.

The present invention is aimed at providing a collapsible building module which may be transported in a collapsed condition and erected relatively quickly to form a building either alone or with other modules.

### SUMMARY OF THE INVENTION

With the foregoing in view the invention in one aspect resides broadly in a collapsible building module including:

a floor panel;

a plurality of wall panels, each having an upper end and a lower end and being connected to said floor panel at or adjacent their lower ends for pivoting movement relative to said floor panel about respective pivot axes at or adjacent their lower ends between an erected position in which they stand up from said floor panel and a stowed position in which they rest on said floor panel or on top of one another;

a roof panel operatively connected to one of said wall panels at or adjacent its upper end for pivoting movement relative thereto about a pivot axis adjacent said upper end; and

securing means for securing selected adjacent panels together in the erected position.

In another aspect the invention resides broadly in a collapsible building module including:

a floor panel;

a plurality of wall panels, each having an upper end and a lower end and being adapted to be connected to said floor panel at or adjacent their lower ends for pivoting movement relative to said floor panel about respective pivot axes at or adjacent their lower ends between an erected position in which they stand up from said floor panel and a stowed position in which they rest on said floor panel or on top of one another;

a roof panel adapted to be connected to one of said wall panels at or adjacent its upper end for pivoting movement relative thereto about a pivot axis adjacent said upper end; and

securing means for securing selected adjacent panels together in an erected position.

Advantageously, the collapsible building module may be transported in a collapsed condition, in which the wall panels are in the stowed position, thus requiring considerably less shipping space than when the wall panels are in the erected position. Further, the collapsible building module may be erected relatively quickly from its collapsed condition by moving the wall panels from the stowed position to the erected position in a generally rotational movement through a quarter turn and then securing the adjacent wall panels together in an erected position whereupon the roof panel may be moved to an erected position resting on said upper ends of the wall panels.

Preferably, the wall panels are such that when they are in the stowed position (that is, when the module is in the collapsed condition) the wall panels lie parallel to the upper face of the floor panel and together with the floor panel form a compact stack. In a preferred form a number of like collapsed modules can be stacked in a shipping container thereby allowing transportation of sufficient modules to erect a house for emergency housing of a satisfactory size at relatively low transportation costs.

Preferably, said plurality of wall panels includes two opposed end wall panels and a side wall panel therebetween to which the roof panel is operatively connected. In such form it is preferred that the upper ends of the end wall panels be inclined to the floor panel when in the erected position to define a suitable support for the roof panel whereby the roof panel resting thereon will have a suitable slope for discharging rain or snow to one side as the case may be.

Preferably, the collapsible building module includes support means for supporting the floor panel in an elevated position above the ground. In a preferred form, the support means includes a plurality of jacking legs adapted to rest on the ground and to be operated to adjust the height of the floor relative to each jack. In one form in which the floor panel includes a plurality of spaced apart beams supporting thereon flooring such as plywood, the jacking legs are each operatively connected to the beams for pivoting movement from a stowed or retracted position in which they rest within the envelope of the floor panel, that is between the beams, to an in-use or extended position in which they can be operated to level the floor in a selected elevated position.

Preferably, the collapsible building module also includes an eaves panel which is adapted to cooperate with the roof panel in the erected position to extend the roof beyond the side wall so as to provide shade for the side wall and so that rainwater will be discharged from the roof at a desired distance from the wall panel. In one form of the invention, the eaves panel is connected to the side wall panel to which the roof panel is connected for pivoting movement relative thereto while in another form, the eaves panel is connected to the roof panel.

Preferably at least some of the wall panels have openings therein for the provision of windows and doors. In a preferred form, windows and doors are fitted to the panels and supported by temporary support members when the module is in the collapsed state.

In another aspect the invention resides broadly in a building comprising at least two collapsible building modules as previously described fitted side by side and secured together. Thus, it is preferred that the modules include module securing means for securing adjacent modules together.

Preferably, the building also includes a ridge panel fitted in a space between the roof panels of the adjoining modules. In such form, it is preferred that the ridge panel have openings therein for providing ventilation and be height adjustable to expose more or less of the openings to the atmosphere. In one preferred form of building, the roof panel is formed to be narrower in plan width than the inclined end of the end walls so that a space is provided between adjacent opposed roof panels so as to accommodate a ridge panel of the type previously described.

In another aspect the invention resides broadly in a method of erecting a building from collapsible building modules, including:

providing two collapsible building modules of the type previously described;

positioning the two modules so that the floor panels are in abutting alignment and the wall panels to which the respective roof panels are connected are spaced apart and opposite;

raising the respective wall panels about their respective pivot axes to their respective erected positions;

securing selected adjacent walls in their respective erected positions;

raising the roof panels to their respective erected positions; and

securing the roof panels in their respective erected positions.

Preferably, the method includes the step of elevating the modules above the ground on the support means. In the case where the support means includes jacking legs the method includes moving the jacking legs to their respective in-use positions.

In another aspect the invention resides broadly in a two part hinge for connecting adjacent wall and/or floor panels together, including:

a first hinge part adapted to be secured to the end of a first wall or floor panel and a second hinge part adapted to be secured to the end portion of a second wall or floor panel, the first and second hinge parts including respective inter-engaging portions adapted to allow generally arcuate relative movement of the first and second hinge parts between a first position in which the second part disengages from the first part and a second position in which the two parts are generally aligned.

Preferably, each hinge part includes a generally trough shaped cap portion adapted to receive therein the end portion of a wall or floor panel. In one such preferred form, the two hinge parts are formed in extruded aluminium with one having an arcuate recess extending along its length and the other part having a complementary arcuate protuberance extending along its length and adapted to slidably engage in the slot of the other part to allow relative pivotal movement therebetween. It is also preferred that such form be arranged to prevent flow of water from one side to the other. Advantageously, in such form the hinge may be used to connect adjoining roof panels or roof panel and eaves panel together to form an extended roof without fear of any significant amount of rainwater passing between the adjoining panels.

Preferably, the first and second hinge parts include complementary stop means for preventing relative movement thereof beyond the second position. It is also preferred that one of the hinge parts have means for deflecting rainwater from the other hinge part, for example a skirt portion.

In another aspect the invention resides broadly in a three part hinge for connecting adjacent wall and/or roof panels together, including:

a first hinge part;

a second hinge part connected to the first hinge part for pivoting movement relative thereto about a first pivot axis at or adjacent one side between a first position in which the two parts are generally angularly aligned and a second position in which the two parts are angularly displaced; and

a third hinge part connected to said first hinge part for pivoting movement relative thereto about a second pivot axis at or adjacent the other side between a first position in which the two parts are generally angularly aligned and a second position in which the two parts are angularly displaced; and

said first hinge part being adapted to be connected to a first wall or roof panel, said second hinge part being adapted to be connected to a second wall or roof panel and said third hinge part being adapted to be secured to the end of a third wall or roof panel.

In yet another aspect, the invention resides broadly in a panel for a building having a core made of a lightweight expandable material such as polystyrene foam, a cap extending along at least one edge of said core and covering a portion of the side face of said core and a layer of an impermeable material covering one face of said core and at least a portion of said cap. Preferably, both side faces of the core are covered by a layer of impermeable material.

Preferably, said cap is formed of extruded aluminium and said layer of impermeable material is sheet aluminium.

Preferably, said cap extends fully about the perimeter of said core and preferably, said layer or layers of impermeable covering overlay a portion of the cap fully around the perimeter to prevent moisture entering at any point.

In still yet another aspect the invention resides broadly in a method of forming a building panel, including:

providing a sheet of core material formed from an expandible material;

fitting an edge cap to at least one edge of said sheet of core material with at least a part of said edge cap overlaying one side face of said core material; and

fitting a sheet of impermeable material to said one face such that it overlays at least a part of said edge cap.

### BRIEF DESCRIPTION OF THE DRAWINGS

In order that the invention may be more readily understood and put into practical effect, reference will now be made to the accompanying drawings which illustrate a preferred embodiment of the invention and wherein:

FIG. 1 is a schematic end elevation of a collapsible building module according to the present invention in its collapsed condition;

FIG. 2 is a schematic side elevation of the collapsible building module of FIG. 1 in its collapsed condition;

FIG. 3 is a top plan view of the module of FIG. 1 in the collapsed state;

FIG. 4 is a schematic end elevation of two building modules as shown in FIG. 1 disposed in a shipping container for transportation to site;

FIG. 5 is a schematic end elevation of the building modules of FIG. 4 on site in abutting relationship to form a building;

FIG. 6 is a schematic end elevation of the building of FIG. 5 with the side walls partly erected;

FIG. 7 is a schematic end elevation of the building of FIG. 5 with the side walls fully erected;

FIG. 8 is a schematic end elevation of the building of FIG. 5 with one pair of end walls erected;

FIG. 9 is a schematic end elevation of the building of FIG. 5 showing the other pair of end walls being erected;

FIG. 10 is a schematic end elevation of the building of FIG. 5 showing both pairs of end walls erected;

FIGS. 11 to 15 are sequential schematic end elevations of the building of FIG. 5 showing the roof panels and eaves panels being erected;

FIG. 16 is an enlarged form of FIG. 15;

FIG. 17 is a schematic side elevation of the collapsible building module of FIG. 1 in its erected condition;

FIGS. 18 and 19 are expanded end elevations of the joint region of the building of FIG. 5, shown erected in FIGS. 15, 16 and 17, showing the connection between one side wall panel, a roof panel and an eaves panel marked as Detail 18;

FIG. 20 is an expanded end elevation of the roof ridge region of the building of FIG. 5, shown erected in FIGS. 15, 16 and 17, at one end showing the connection between the roof panels and the end wall panels and the location of the ridge panel marked as Detail 20;

FIG. 21 is an expanded end elevation of a part of the floor of the building of FIG. 5, shown erected in FIGS. 15, 16 and 17, showing one floor support jack in both the stowed and erected positions marked as Detail 21;

FIG. 22 is an expanded end elevation of a part of the floor of the building of FIG. 5, shown erected in FIGS. 15, 16 and 17, showing the connection between the floor panels of the two modules in the erected position marked as Detail 22;

FIG. 23 is an expanded end elevation of a part of the floor of the building of FIG. 5, shown erected in FIGS. 15, 16 and 17, showing the connection of one wall panel to the floor panel in the erected position marked as Detail 23;

FIG. 24a is a sectional end elevation of a hinge used to connect the end wall panels to the floor panels of the building of FIG. 5 in the collapsed position;

FIG. 24b is a sectional end elevation of a hinge used to connect the end wall panels to the floor panels of the building of FIG. 5 in the erected position;

FIG. 25a is a sectional end elevation of a hinge used to connect the side wall panels to the floor panels of the building of FIG. 5 in the collapsed position;

FIG. 25b is a sectional end elevation of a hinge used to connect the side wall panels to the floor panels of the building of FIG. 5 in the erected position;

FIG. 26 is a pictorial representation of a hinge used to connect the wall panels to the roof panels and eaves panels of the building of FIG. 5 shown erected in FIGS. 15, 16 and 17;

FIG. 27 is a sectional end elevation of the hinge of FIG. 26 in the erected position marked as Detail 18;

FIG. 28 is a sectional end elevation of one part of the hinge of FIG. 27; and

FIG. 29 is a sectional end elevation of a section of a wall or roof panel of the building module of FIG. 5.

### DETAILED DESCRIPTION OF THE DRAWINGS

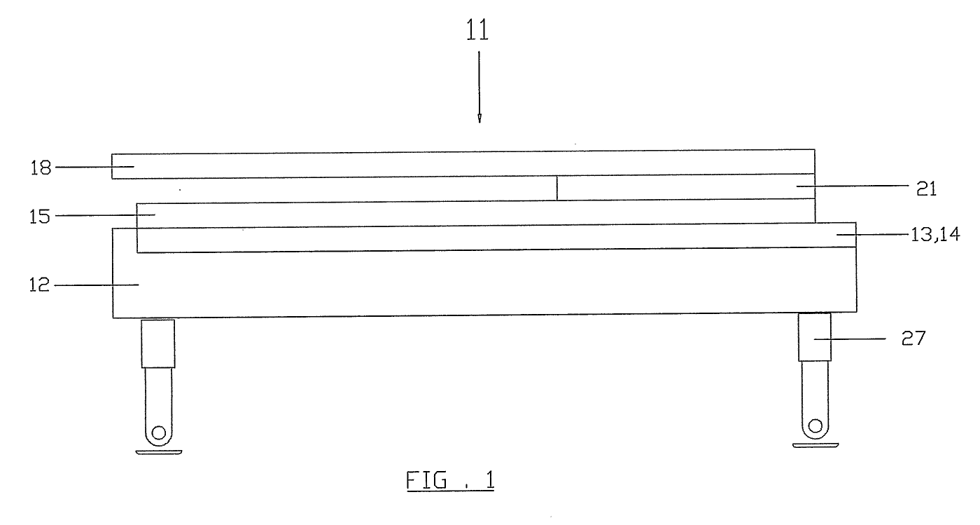

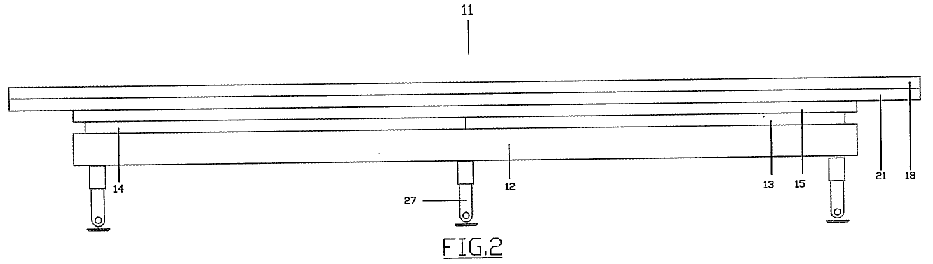

The collapsible building module 11 illustrated in FIG. 1 in its collapsed state includes a floor panel 12, a pair of opposed end wall panels 13 and 14 connected to the floor panel and a side wall panel 15 also connected to the floor panel and which when erected extends between the two end wall panels.

The end wall panels are connected to the floor panel for pivoting movement relative thereto at their lower ends by respective hinge assemblies 16 for pivoting movement relative thereto from a stowed position to an erected position as will be described more fully later. Similarly, the side wall panel is also connected to the floor panel by a hinge assembly 17 also for pivoting movement relative thereto from a stowed position to an erected position.

A roof panel 18 is connected to the side wall panel for pivoting movement relative thereto from a stowed position to an erected position by a hinge assembly 19 as will also be described in more detail later and an eaves panel 21 in turn is connected to the roof panel for pivoting movement relative thereto by the same hinge assembly as also will be described in more detail later. Suitably, the upper ends of the two end wall panels are inclined upwards towards the ridge of the building to provide a support surface for supporting the roof panel thereon at a suitable slope for discharge of rainwater to the side when erected.

When the building module is in the collapsed state all panels are in the stowed position with the two end walls resting directly on the floor panel with their upper edges towards each other and the side wall panel rests on top of the end wall panels and then the eaves panel rests on top of the side wall panel and the roof panel rests on top of the eaves panel. When in the erected state, the wall panels stand vertically up from the floor, the roof panel rests on the upper ends of the end wall panels and is also supported by the side wall panel and the eaves panel is aligned with the roof panel and is connected thereto along its side edge.

The floor panel comprises a perimeter support beam 22 constructed of C-section galvanised steel or aluminium and a plurality of spaced apart C-section cross beams 23 extending from side to side between the opposed side sections of the perimeter beam and marine ply flooring 24 screwed thereto to form the upper skin. A nub 26 extends up from the perimeter support beam along the side of the floor panel above the upper skin to provide a mounting rail for the side wall as will be described in more detail later. In this embodiment the floor panel has a length of 5000 mm, a width of 2300 mm and an overall thickness of 200 mm including the support beams plus 75 mm for the nub which is effective to form part of the side wall when erected.

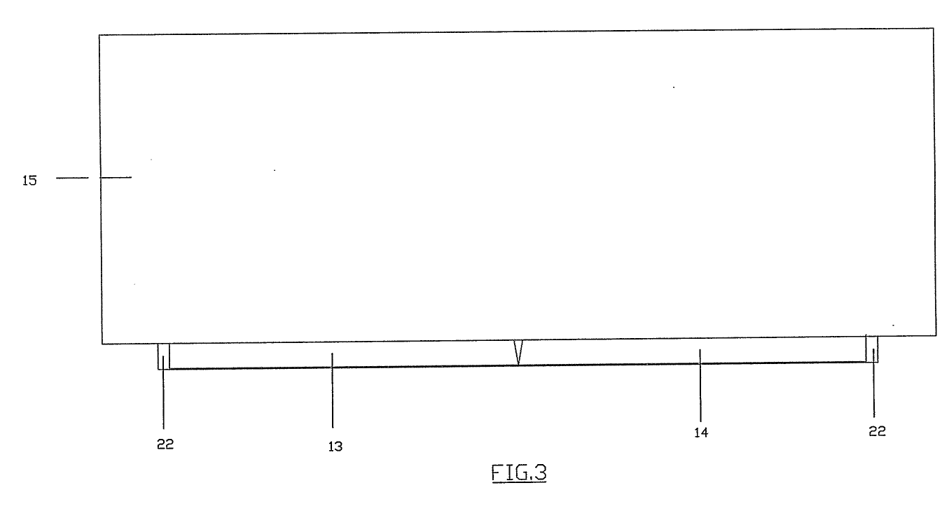

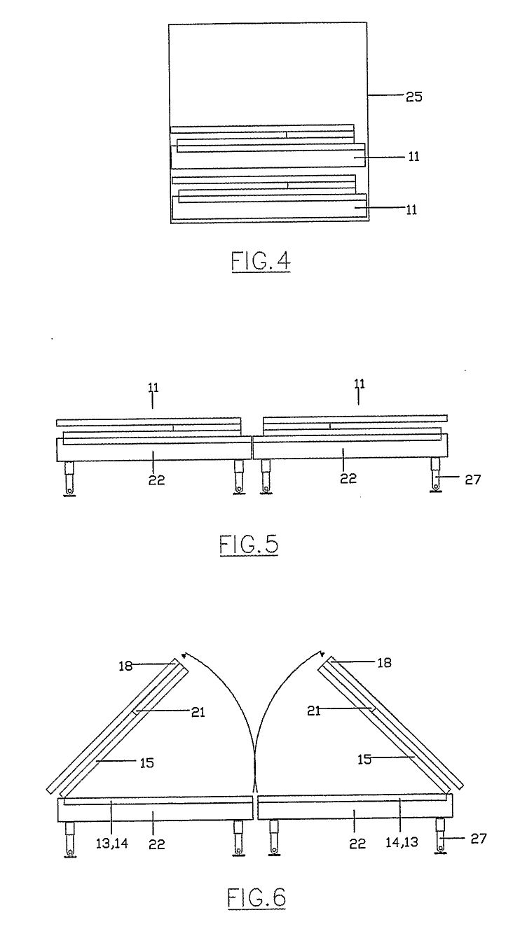

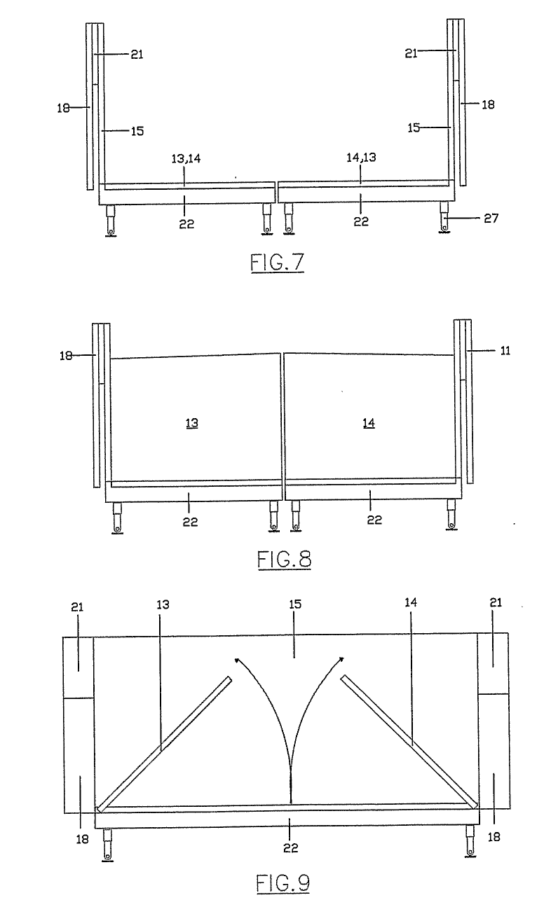

When the module is in the collapsed condition the side wall panel, end wall panels, roof panel and eaves panel lie generally parallel to the floor panel and the upper surfaces of the respective end wall panels lie generally flush with the upper edge of the nub as can be best seen in FIG. 1. Advantageously, the collapsed building module fits neatly into a standard six metre shipping container 25 as indicated in FIG. 4 and four modules can be stacked in such a container and eight in a standard 12 metre container. A plurality of spaced apart jacking legs 27 are pivotally mounted to selected cross beams of the floor panel for supporting the floor at a desired location when erected. The jacking legs are pivotally mounted to the respective beams for movement from a stowed position in which they lie against their respective beams within the envelope of the floor panel to an in-use position depending from the beams and can be screwed up or down by handle 28 to level the floor in the selected location.

The two part hinge assembly 16 includes inter-engaging first and second complementary elongate hinge halves 31 and 32a. The first hinge comprises a mounting base 33 adapted to be secured to the perimeter beam of the floor panel and an arcuate protuberance 34 extending along its length and upwards from the mounting base while the second half has a corresponding arcuate recess 36 towards one end extending along its length and adapted to receive therein the arcuate protuberance of the first hinge half for relative pivoting movement therebetween. Towards its other end, the second hinge half has a recess 37 which receives therein the end portion 38 of the end wall panel 13 or 14 which is secured therein by adhesive, screws, bolts or any other suitable fasteners. In use it will be seen that the first hinge half pivots relative to the second hinge half about axis 40 that being the centre line of the arcuate recess and protuberance.

The hinge assembly 17 is the same as hinge assembly 16 except that instead of the second half 32b having a mounting base it has a recess 38 extending along its length which is adapted to receive therein the nub 26. Thus, hinge assembly 16 pivots about axis 39 and allows the end wall panels to rest against the floor panel when in the stowed position while hinge assembly 17 being connected to the nub allows the side wall to rest on top of the end panels while they are stowed.

The three part hinge assembly 19 includes a plurality of spaced apart first hinge parts 41 interleaved with second and third hinge parts 42 and 43. Suitably, the second hinge part is connected to the first hinge part by a hinge pin 44 which extends through complementary bores 45 and 46 in the first and second parts for pivoting movement relative thereto about a pivot axis 47 which extends along one side of the first hinge half. Similarly, the third hinge part is connected to the first hinge part by a hinge pin 48 which extends through complementary bores 49 and 51 in the first and third parts for pivoting movement relative thereto about a pivot axis 52 which extends along the other side of the first hinge part between a first position in which the two parts are generally angularly aligned and a second position in which the two parts are angularly displaced.

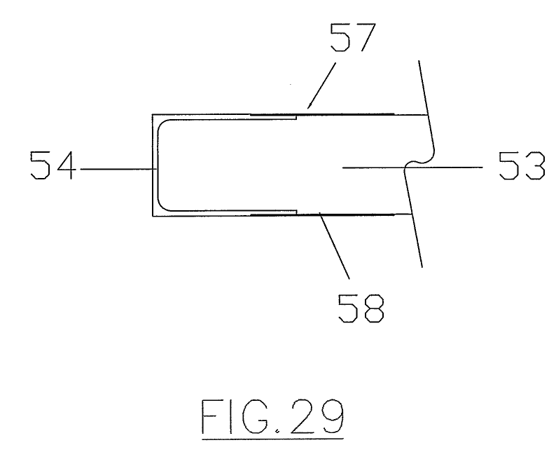

The wall panel 15 illustrated in FIG. 29 has a polystyrene foam core 53 with an extruded aluminium edge cap 54 which extends fully about its perimeter and a sheet aluminium skin 56 covering the opposed side faces 57 and 58 of the foam core and overlaying a portion of the edge cap. The panel is manufactured by first forming the core, then fitting the edge cap and securing it by welding or adhesive and then fitting the aluminium skins to both sides. Advantageously, this manner of manufacture results in a panel which has sufficient strength for connection to other panels for the building module and has flush sides which provide for stacking without damage by adjacent panels and in use do not suffer from ingress of water.

In use, two collapsible building modules (or more if required for other buildings or a larger building) are transported to site in a standard shipping container. On site, two modules are put together in the manner illustrated in FIG. 5, after lowering the jacking legs, with the floor panel of one module abutting the floor panel of the other module along the open side, that is, the side that does not have a side wall, and the two floor panels are secured together by cam lock latches attached to the cross beams 23. The jacking legs 27 can then be adjusted up or down to level the floor as required depending on the condition of the site. Of course, it may be necessary to level the floor to some extent before securing the floor panels together.

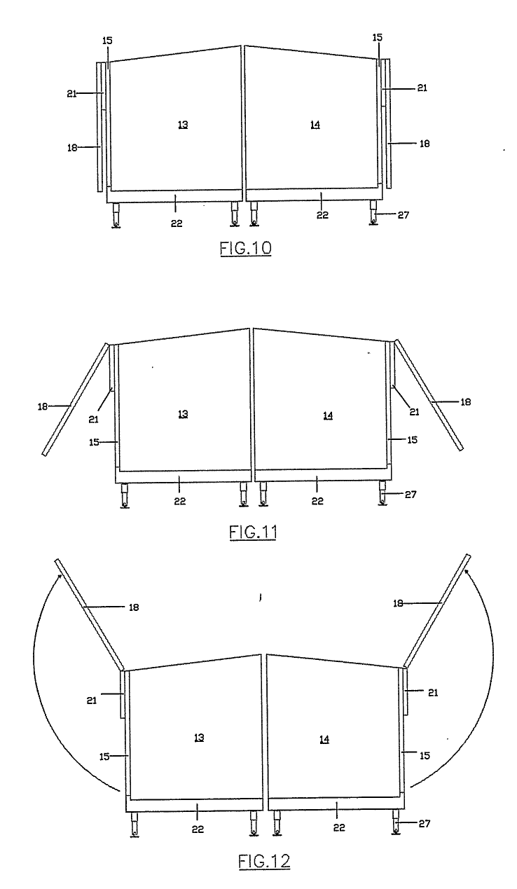

Once the floor panels are secured together and the floor is levelled, the roof panel, eaves panel and side wall panel of one module are raised as a unit by pivoting the side wall panel upwards, with the other panels attached, about pivot axis 39 of the sidewall hinge assembly mounted to the nub as illustrated in FIGS. 6 and 7. Once the sidewall panel is in the vertical position, the opposed end wall panels can be raised to the vertical position by pivoting about pivot axis 40 which extends along the end of the floor panel as illustrated in FIGS. 9 and 10 at right angles to the side panel pivot axis, whereupon the sidewall panel may be secured to the end wall panels by suitable fasteners such as cam lock latches, screws, bolts or the like as desired. The joints may be sealed with a flexible sealant such as Silastic if desired. The adjoining module is then erected in the same manner but of course it may be erected at the same time if a sufficient labour force is available.

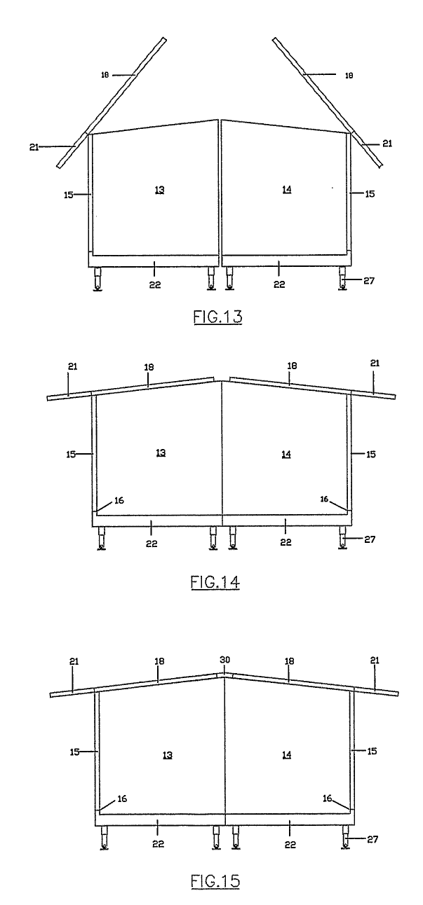

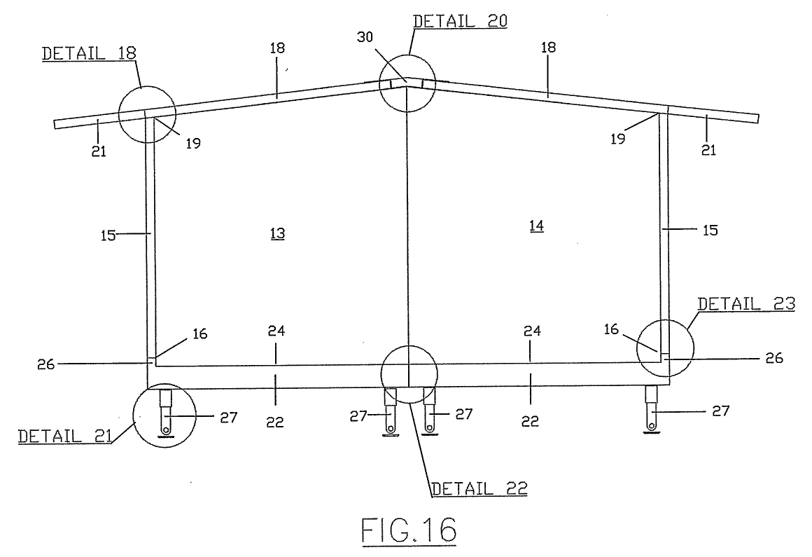

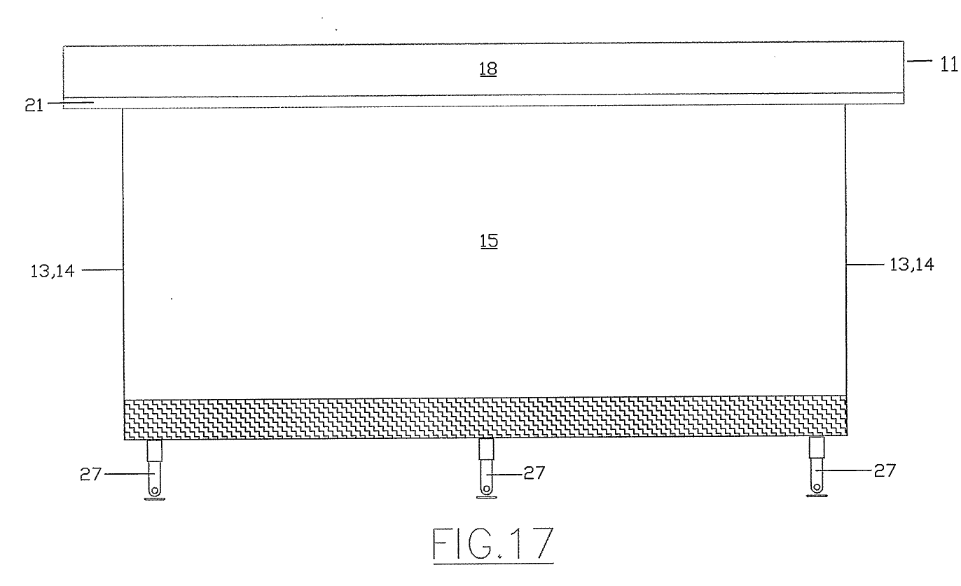

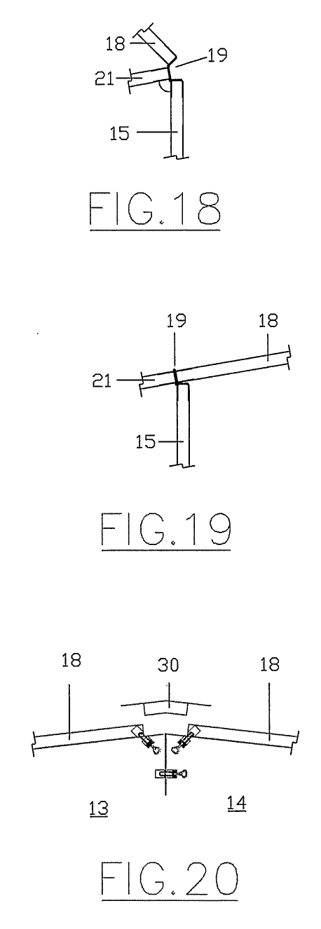

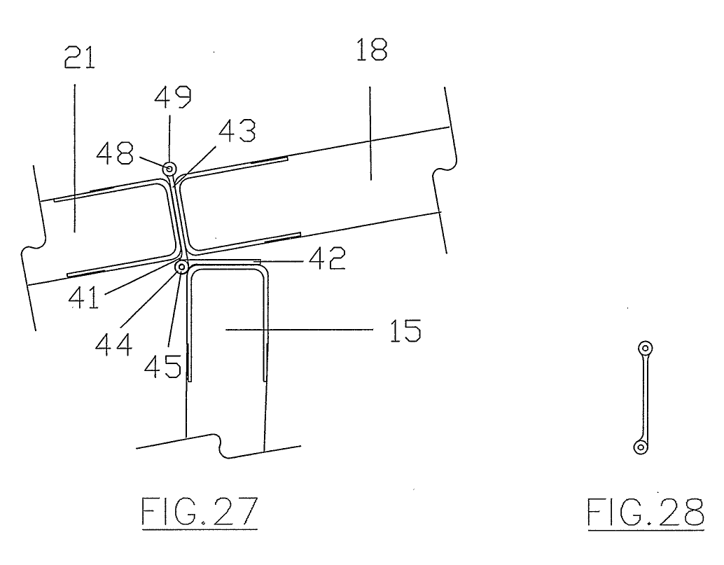

Once the wall panels have been erected and secured, the roof and eaves panels may be raised to the erected position as illustrated in FIGS. 11 to 14. Notably, it will be appreciated from FIG. 27 that as the roof panel is raised, its lower end will eventually abut the upper end of the eaves panel and become aligned therewith whereupon it will cause the eaves panel to move to its erected position as the roof panel moves into its erected position resting on the upper ends of the end wall panels.

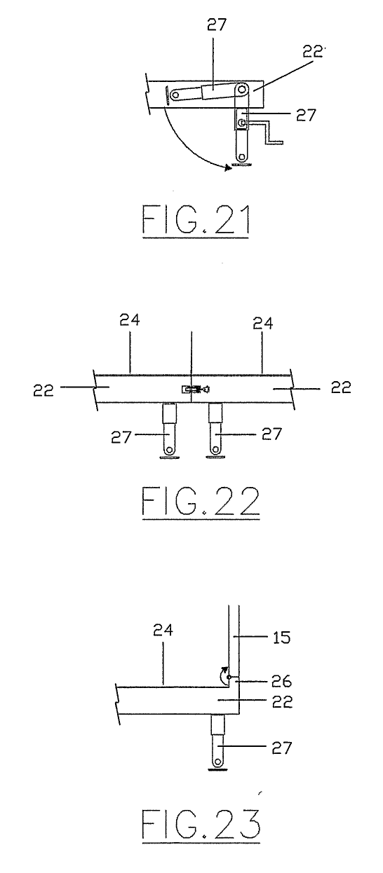

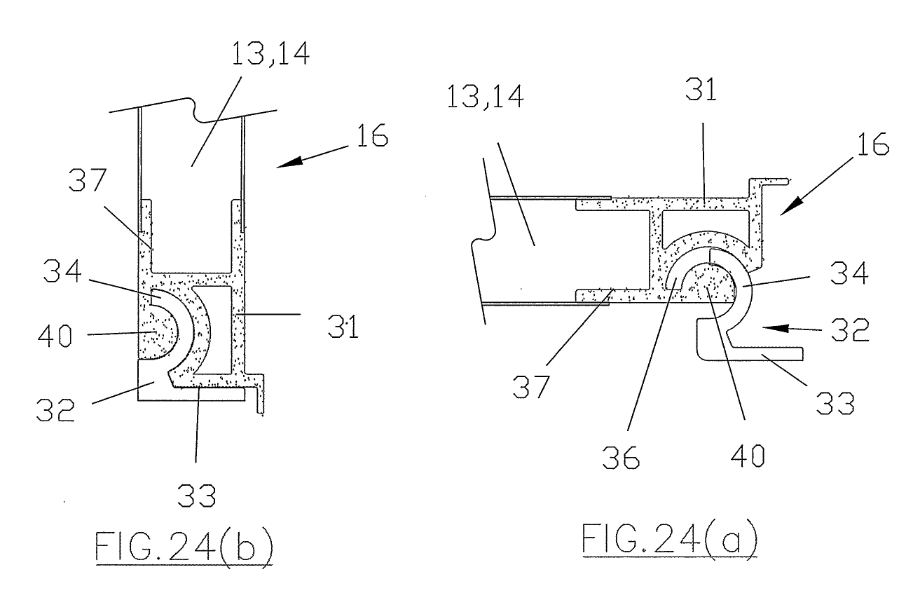

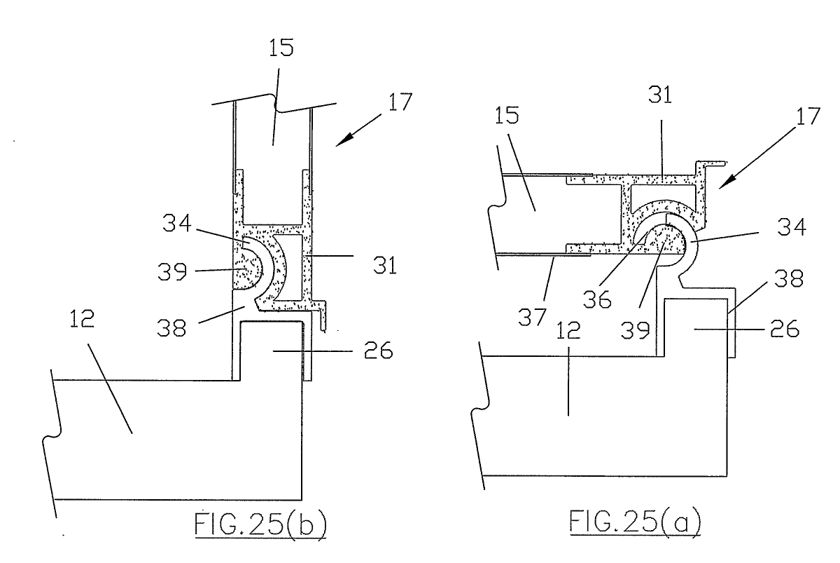

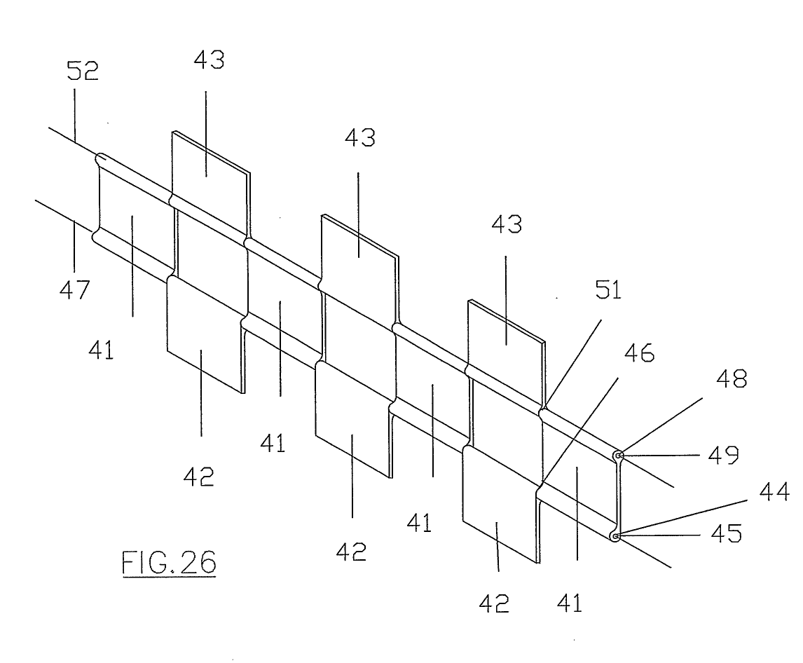

Once the roof panels are in the erected position, they may be secured to the end wall panels by any suitable fasteners such as cam lock latches as illustrated in FIG. 20, screws, bolts or the like and then the ridge panel 30 may be fitted to the gap between the two roof panels as will be understood from FIG. 20.

It will be appreciated that door and window openings may be provided in any wall panels and doors and windows may be fitted prior to shipping to site. It will also be appreciated that two or more buildings as previously described may be erected side by side to form a larger building with means of communication being provided by cutting doorways in abutting walls.

The foregoing description has been given by way of illustrative example of the invention and many modifications and variations which will be apparent to persons skilled in the art may be made without departing from the spirit and scope of the invention as defined by the appended claims.

1. A collapsible building module including:
a floor panel;
a plurality of wall panels, each having an upper end and a lower end and being connected to said floor panel at or adjacent their lower ends for pivoting movement relative to said floor panel about respective pivot axes at or adjacent their lower ends between an erected position in which they stand up from said floor panel and a stowed position in which they rest on said floor panel or on top of one another;
a roof panel operatively connected to one of said wall panels at or adjacent its upper end for pivoting movement relative thereto about a pivot axis adjacent said upper end in such manner that in the stowed position said roof panel is above said one wall panel and when said one wall panel is in the erected position said roof panel before being pivoted to the erected position lies outside said one wall panel and can be pivoted about its respective pivot axis to an erected position; and
securing means for securing selected adjacent panels together in the erected position.

2. A collapsible building module including:
a floor panel;
a plurality of wall panels, each having an upper end and a lower end and being adapted to be connected to said floor panel at or adjacent their lower ends for pivoting movement relative to said floor panel about respective pivot axes at or adjacent their lower ends between an erected position in which they stand up from said floor panel and a stowed position in which they rest on said floor panel or on top of one another;
a roof panel adapted to be operatively connected to one of said wall panels at or adjacent its upper end for pivoting movement relative thereto about a pivot axis adjacent said upper end in such manner that in the stowed position said roof panel is above said one wall panel and when said one wall panel is in the erected position said roof panel before being pivoted to the erected position lies outside said one wall panel and can be pivoted about its respective pivot axis to an erected position; and
securing means for securing selected adjacent panels together in an erected position.

3. A collapsible building module according to claim 1, wherein in the collapsed state, the wall panels lie parallel to the upper face of the floor panel and together with the floor panel form a compact stack.

4. A collapsible building module according to claim 1, wherein said side floor panel, said wall panels and said roof panel are selected such that a collapsed module fits inside a standard shipping container with the floor panel horizontal.

5. A collapsible building module according to claim 4, wherein said side floor panel, said wall panels and said roof panel are selected such that a plurality of collapsed modules may be stacked inside a standard shipping container with the floor panel horizontal.

6. A collapsible building module according to claim 1, wherein said plurality of wall panels includes two opposed end wall panels and a side wall panel therebetween to which the roof panel is operatively connected.

7. A collapsible building module according to claim 6, wherein the end wall panels support the roof panel on their upper ends when erected.

8. A collapsible building module according to claim 7, wherein the upper ends of the end wall panels are inclined to the floor panel when in the erected position.

9. A collapsible building module according to claim 1, including support means for supporting the floor panel in an elevated position above the ground.

10. A collapsible building module according to claim 9, wherein the support means includes a plurality of jacking legs adapted to rest on the ground and to be operated to adjust the height of the floor relative to each jack.

11. A collapsible building module according to claim 10, wherein the floor panel includes a plurality of spaced apart beams and the jacking legs are connected to the beams for pivoting movement from a stowed or retracted position in which they rest within the envelope of the floor panel.

12. A collapsible building module according to claim 6, including an eaves panel which is adapted to cooperate with the roof panel in the erected position to extend the roof beyond the side wall.

13. A collapsible building module according to claim 12, wherein the eaves panel is connected to the side wall panel to which the roof panel is connected for pivoting movement relative thereto.

14. A collapsible building module according to claim 12, wherein the eaves panel is connected to the roof panel.

15. A building comprising at least two collapsible building modules as claimed in claim 1, fitted side by side and secured together.

16. A building according to claim 15, including a ridge panel fitted between the roof panels of the adjoining modules.

17. A building according to claim 16, wherein said ridge panel has openings therein for providing ventilation and includes height adjustment means for adjusting its height relative to said roof panels.

18. A method of erecting a building from collapsible building modules, comprising:
providing two collapsible building modules as claims in claim 1;
positioning the two modules so that the floor panels are in abutting alignment and the wall panels to which the respective roof panels are connected are spaced apart and opposite;
raising the respective side walls and end walls about their respective pivot axes to their respective erected positions;
securing selected adjacent walls in their respective erected positions;
raising the roof panels to their respective erected positions; and
securing the roof panels in their respective erected positions.

19. A two part hinge for connecting adjacent wall and/or floor panels together, including:
a first hinge part adapted to be secured to the end of a first wall or floor panel and a second hinge part adapted to be secured to the end portion of a second wall or floor panel, the first and second hinge parts including respective inter-engaging portions adapted to allow generally arcuate relative movement of the first and second hinge parts between a first position in which the second part disengages from the first part and a second position in which the two parts are generally aligned.

20. A hinge according to claim 19, wherein each hinge part includes a generally trough shaped cap portion adapted to receive therein the end portion of a wall or floor panel.

21. A hinge according to claim 20, wherein the two hinge parts are formed in extruded aluminium with one having an arcuate recess extending along its length and the other having a complementary arcuate protuberance extending along its length and adapted to slidably engage in the slot of the other part to allow relative pivotal movement therebetween.

22. A hinge according to claim 21, wherein the first and second hinge parts include complementary stop means for preventing relative movement thereof beyond the second position.

23. A hinge according to claim 22, wherein at least one of the hinge parts has means for deflecting rainwater from the other hinge part when in use.

24. A three part hinge for connecting adjacent wall and/or roof panels together, including:
a first hinge part;
a second hinge part connected to the first hinge part for pivoting movement relative thereto about a first pivot axis at or adjacent one side between a first position in which the two parts are generally angularly aligned and a second position in which the two parts are angularly displaced; and
a third hinge part connected to said first hinge part for pivoting movement relative thereto about a second pivot axis at or adjacent the other side between a first position in which the two parts are generally angularly aligned and a second position in which the two parts are angularly displaced; and
said first hinge part being adapted to be connected to a first wall or roof panel, said second hinge part being adapted to be connected to a second wall or roof panel and said third hinge part being adapted to be secured to the end of a third wall or roof panel.

25. A panel for a building having a core made of a lightweight expandable material such as polystyrene foam, a cap extending along at least one edge of said core and covering a portion of the side face of said core and a layer of an impermeable material covering one face of said core and at least a portion of said cap.

26. A panel according to claim 25, wherein both side faces of the core are covered by a layer of impermeable material.

27. A panel according to claim 25, wherein said cap extends fully about the perimeter of said core.

28. A panel according to claim 27, wherein said layer or layers of impermeable covering overlay a portion of the cap fully around the perimeter.

29. A method of forming a building panel, including:
providing a sheet of core material formed from an expandible material;
fitting an edge cap to at least one edge of said sheet of core material with at least a part of said edge cap overlaying one side face of said core material; and
fitting a sheet of impermeable material to said one face such that it overlays at least a part of said edge cap.

30. (canceled)

31. (canceled)

32. (canceled)

33. (canceled)
